(19) United States
(12) Patent Application Publication
(10) Pub. No.: US 2008/0047663 A1
(43) Pub. Date: Feb. 28, 2008

(54) Apparatus and method for bonding anisotropic conductive film using laser beam

(75) Inventors: Gi-Jung Nam, Seoul (KR); No-Heung Kwak, Seoul (KR)

Correspondence Address: JORDAN AND HAMBURG LLP, 122 EAST 42ND STREET, SUITE 4000, NEW YORK, NY, 10168, US

(73) Assignee: Jettech Ltd., Kyunggi-Do (KR)

(21) Appl. No.: 11/977,396

(22) Filed: Oct. 24, 2007

Related U.S. Application Data
(62) Division of application No. 11/072,556, filed on Mar. 3, 2005.

(51) Int. Cl. B29C 65/16

(52) U.S. Cl. 156/272.8

(57) ABSTRACT

An anisotropic conductive film bonding apparatus and a method using a laser beam instead of thermal welding using a hot bar are disclosed. The apparatus includes a light source for generating a laser beam, a laser beam transmitter for guiding the laser beam from the light source to project the laser beam onto a connecting portion, a jig, on which the substrate, the ACF, and the material are accumulated, for projecting the laser beam on the accumulated material, a manipulation panel, and a controller for setting intensity and projection manner of the laser beam and pressure and for controlling overall operation of the apparatus. The process using the hot bar as a heat source for the connection of the anisotropic conductive film is replaced with the process using a diode laser, so that reliability and precision of the process can be achieved, the processing time can be also reduced, and full-automated process can enhance productivity

### BACKGROUND OF THE INVENTION

1. Field of the Invention

The present invention relates to technology for bonding an anisotropic conductive film used to mount electronic components, semiconductors, and flat panel displays such as liquid crystal displays, plasma display panels, electro luminescent displays, and more particularly, to an apparatus and a method for bonding an anisotropic conductive film using laser beam capable of alternating a conventional thermal welding technology due to a hot bar.

2. Description of the Related Art

Generally, anisotropic conductive films (ACF) are materials, such as double-sided adhesive tapes, formed from minute conductive balls, which are mixed with adhesive and hardened by heat. If high pressure is applied to the ACF, the conductive balls contacting pads (bumps) of a circuit pattern are destroyed such that the conductive balls allow electricity to pass through the pads (bumps), and the adhesives fill uneven surfaces except the pads (bumps) and are hardened so as to bond the pads to each other. In other words, the ACF is an adhesive film in which conductive particles (referred to as conductive balls), such as plastics coated with metal or metal particles, are distributed, and is widely used to electrically connect LCD panels to tape carrier packages (TCP) and printed circuit boards (PCB) to TCPs in mounting the LCD. Due to the development of LCD technology, reliability of connection of the ACF is being enhanced and connection pitches are becoming increasingly small, and as a result, it is possible to implement “Chip On Glass” (COG) mounting technology for mounting a bare chip by directly connecting the bare chip to the LCD panel.

The connecting of the ACF is implemented such that, after locating the ACF between two objects to be connected to each other, when the ACF is heated (at temperature of 160 degrees centigrade to 180 degrees centigrade for a duration of 10 to 20 sec) and pressed (at 2 Mpa to 3 Mpa), the adhesive in the ACF is melted and the distributed conductive balls connect facing electrodes to each other to obtain conductivity, and at that time, the adhesive fills the space between neighboring electrodes. At that time, since the conductive particles are independent of one another, the ACF is insulated in the horizontal direction, but electrically connected in the vertical direction between the pads (bumps). The high adhesive force of the adhesive maintains the connection between the conductive particles and the electrodes. Therefore, the characteristics of the adhesive have an effect upon the reliability of the connection of the ACF.

In the early stages of ACF development, thermoplastic resin such as stylene-based block copolymer was used as the adhesive. The thermoplastic resin exhibits excellent reparability due to its solubility in general solutions, but has a high connecting resistance due to its weak heat resistance and low melting point. Due to these characteristics of the thermoplastic resin, a thermosetting resin such as epoxy resin, or the like, is now used in view of enhancement of the connection reliability, and more particularly, thermosetting resins, in which crosslinked polymers are distributed, are used as the adhesive in order to loosen stress generated due to the connection and to provide the reparability. The connection reliability of the ACF is enhanced by using the thermosetting resin as the adhesive, and is obtained by optimizing type, diameter, and amount of conductive particles. The ACF having excellent reliability is widely used as material for connecting the LCD, and can be applied to flat panel displays, such as EL, PDP, or the like, requiring high electric current and high voltage. Though the ACF is widely used in mounting the LCD, the ACF can be used as a material for semiconductor mounting, such as Chip On Board, Chip On Film, or the like, due to the characteristics such as the connection reliability, minute connection, and low-temperature connection.

According to the conventional art, when two media are connected to each other by the ACF, since it is necessary that temperature, pressure, and time be kept constant, in view of characteristics of the thermosetting resin, as shown in FIG. 1a, the contacting surfaces are pressed and thermal-welded by a device equipped with a hot bar having a heater. By referring FIG. 1a, the ACF 104 is positioned between glass 102 and an IC 106, and then the hot bar 108 presses the ACF 104 in the direction depicted by the arrow at a high temperature to connect the glass 102 to the IC 106.

The bonding process for attaching the IC to the LCD substrate using the above-described technology, as shown in FIG. 1b, includes a) preparation step for preparing a substrate 112, b) pre-bonding step for lightly attaching an ACF 114 to the substrate 112, c) stripping step for stripping a protection film 114a off the ACF 114, d) placement step for placing a material 116 to be connected, e) main bonding step for pressing the hot bar 118 to weld the hot bar 118, and f) finishing step. As shown in FIG. 1b, according to the conventional ACF connecting process, the ACF 114 is placed on the substrate 112 to which the ACF 114 is connected and the ACF 114 and the substrate 112 are pre-bonded. After that, the protecting film 114a is stripped off the ACF 114 and materials (such as flexible printed circuits (FPC), IC, or the like) are attached to the ACF 114. After the attachment, the hot bar 118 is pressed to weld. After welding completion, the hot bar 118 is lifted and a worker checks the connection state. Though the connection is performed for about 3 sec to 5 sec at 60 degrees centigrade to 90 degrees centigrade and 0.20 Mpa to 0.29 Mpa in the pre-bonding step, the connection is performed by heating the heater of the hot bar as a heat source for 5 sec to 20 sec at 160 degrees centigrade to 210 degrees centigrade and 24.5 Mpa to 58.5 Mpa (conditions vary depending upon the ACF type and thickness).

As such, according to the conventional art, the ACF is attached between two faces to be connected and the uppermost component is heated and pressed by the hot bar under uniform pressure, so that the thermosetting resin is hardened with the lapse of time. As a result, the two contacting surfaces are connected to each other, and the electricity flows only in one direction due to the conductive particles that are distributed in the film. Since the heat transfers to the ACF through the surface of the component placed at the upper side and the component itself, it is important to satisfy a uniform distribution of heat transfer.

However, according to the conventional thermal-welding process and apparatus using the hot bar, since heat necessary for the thermal-welding has been obtained and adjusted by heating the hot bar using the heater, it is difficult to uniformly heat the hot bar, efficiency of heat transformation deteriorates due to high heat consumption at portions except for the connecting portion, and the surface of the hot bar is contaminated during continuous use of the hot bar such that it is difficult to guarantee reproducibility. Moreover, it is difficult to optimize the connecting condition according to uses of the objects to be connected, and in a semi-automatic process, quality of the connection is dependent upon the experience and skill of the worker.

### SUMMARY OF THE INVENTION

Therefore, the present invention has been made in view of the above and/or other problems, and it is an object of the present invention to provide an anisotropic conductive film bonding apparatus for heating only a connecting portion using laser beam instead of a hot bar using a heater as a heat source in the thermal-welding for the connection of displays such as LCDs, PDPs, LEDs, or the like using an anisotropic conductive film, such that time for increasing temperature required for the connection is reduced, reliability and reproducibility of the connection process are enhanced by precisely and automatically controlling output of the laser beam, and processing time is also reduced, and a method performed by the anisotropic conductive film bonding apparatus.

In accordance with the present invention, the above and other aspects can be accomplished by the provision of an anisotropic conductive film bonding apparatus for connecting a material to a substrate using an anisotropic conductive film, the apparatus including a laser beam source for generating a laser beam with a predetermined wavelength based on a control signal, a laser beam transmission device for guiding the laser beam from the laser beam source to project the laser beam onto a connecting portion, a jig, on which the substrate, the anisotropic conductive film, and the material are accumulated, for projecting the laser beam transmitted by the laser beam transmission device onto the accumulated material and for pressing the accumulated material according to the control signal, a manipulation panel for manipulation, and a controller for setting intensity and projection manner of the laser beam and pressure according to an input from the manipulation panel and for controlling overall operation of the anisotropic conductive film bonding apparatus.

In accordance with the present invention, the above and other aspects can be accomplished by the provision of an anisotropic conductive film bonding method for positioning an anisotropic conductive film between a substrate and a material to be connected and for connecting the substrate to the material to be connected using the anisotropic conductive film, the method including the steps of generating a laser beam with a predetermined wavelength, projecting the laser beam on the substrate and the material for a predetermined time, pressing the material during the projection of the laser beam, and connecting the substrate to the material such that the substrate or the material absorbs the laser beam and is heated to melt adhesive in the anisotropic conductive film, and conductive balls in the anisotropic conductive film are destroyed due to the pressing to provide unidirectional conductivity to the anisotropic conductive film.

As described above, the anisotropic conductive film bonding apparatus according to the present invention welds the anisotropic conductive film using a laser beam instead of the hot bar as the conventional heat source. The laser beam is absorbed in a portion to be connected and heat is generated therefrom. The heat becomes a heat source for the thermal welding of the anisotropic conductive film. Since the heat is generated from only the connecting portion due to high optical energy per unit area, effect of heat transformation is excellent. Since the output of the laser beam can be precisely controlled, the worker does not easily influence the reproducibility of the process and quality. Moreover, since high energy is provided in a short time and temperature required to connect the anisotropic conductive film can be obtained rapidly, the processing time can be also reduced.

### BRIEF DESCRIPTION OF THE DRAWINGS

These and/or other aspects and advantages of the present invention will become apparent and more readily appreciated from the following description of the embodiments, taken in conjunction with the accompanying drawings, in which:

FIG. 1a is a schematic view illustrating a conventional anisotropic conductive film bonding apparatus;

FIG. 1b is a view illustrating a conventional anisotropic conductive film boding process;

FIG. 2 is a schematic view illustrating the principle of laser welding adopted in the present invention;

FIG. 3 is a graph illustrating energy absorption of materials to be connected during the laser welding utilized in the present invention; and

FIG. 4 is a block diagram illustrating an anisotropic conductive film bonding apparatus according to the preferred embodiment.

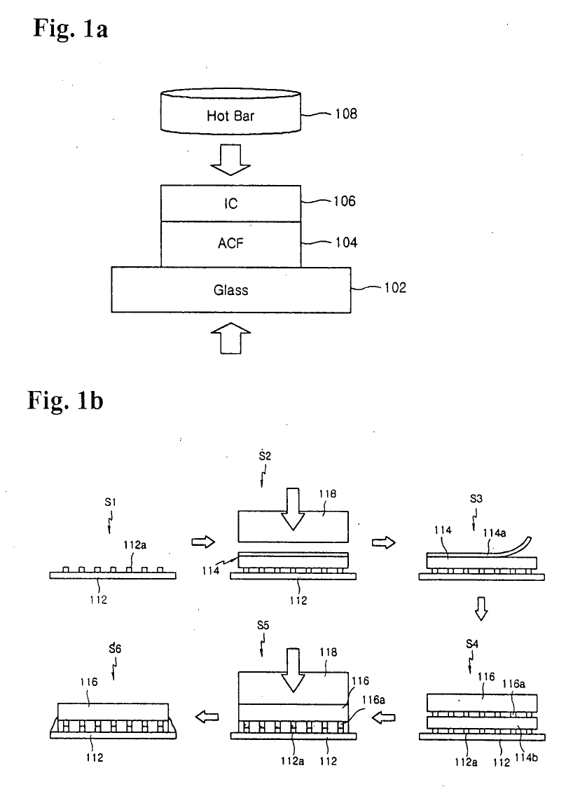

### DESCRIPTION OF THE PREFERRED EMBODIMENTS

Hereinafter, the preferred embodiment of the anisotropic conductive film bonding apparatus and method according to the present invention will be described in detail with reference to the accompanying drawings.

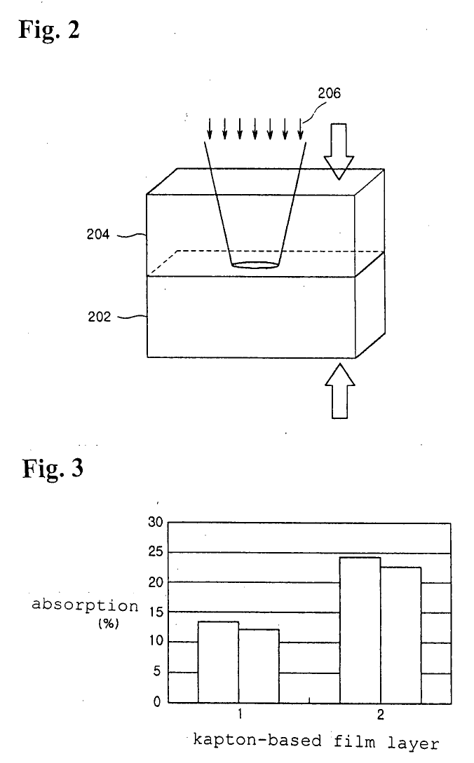

FIG. 2 is a schematic view illustrating the principle of a laser welding adopted in the present invention, and FIG. 3 is a graph illustrating energy absorption of materials to be connected during the laser welding utilized in the present invention.

Transmission welding for welding nonmetal or plastic using a laser beam uses the fact that after contacting two materials 202 and 204 to be connected to each other, as shown in FIG. 2, the laser beam is projected to the contacting portion of the media 202 and 204 to generate heat. Referring to FIG. 2, the upper material 204 transmits most of the laser beams being incident in plastic or glass, and the lower material 202, plastic absorbs a predetermined amount of energy of the incident laser beam. The energy of the laser beam absorbed by the lower material 202 is transformed into heat, and the heat causes the two overlapped surfaces of the materials 202 and 204 to be welded together. As a result, the materials 202 and 204 are connected to each other by way of the welded surfaces. Nonmetal and plastic have different permeability and absorption with wavelength of infrared band according to kind thereof.

Transmission welding can be achieved by effectively taking advantage of the permeability and the absorption. A connection process using the anisotropic conductive film is also a process to perform the connection using heat generated due to the laser beam absorption of a kapton type base film and indium tin oxide (ITO) film, the laser beam absorption of the ACF, and characteristics of a glass substrate for transmitting the majority of the wavelengths of the infrared band.

FIG. 3 is a graph illustrating the absorption of the kapton film widely used in flexible printed circuits (FPC) with respect to laser beams of 810 nm.

As shown in FIG. 3, the horizontal axis represents a layer of a kapton film with a thickness of 50 micrometers, and the vertical axis represents absorption (unit: %). First rods of respective layers in the graph indicate the case that the laser beam has a wavelength of 810 nm, and secondary rods of respective layers in the graph indicate the case that the laser beam has a wavelength of 975 nm.

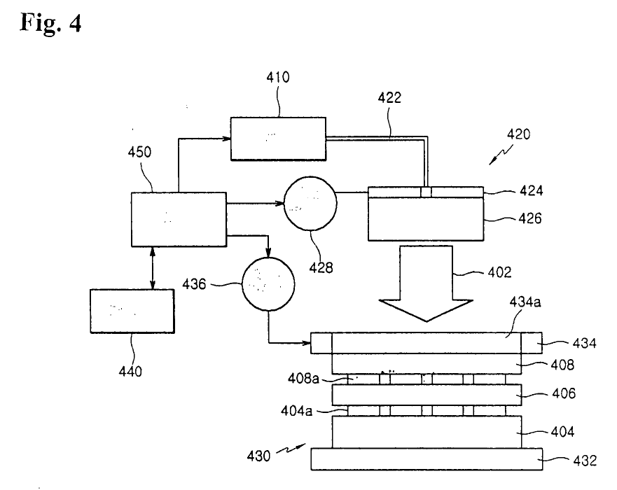

FIG. 4 is a block diagram illustrating an anisotropic conductive film bonding apparatus according to the preferred embodiment of the present invention.

The anisotropic conductive film bonding apparatus according to the preferred embodiment of the present invention, as shown in FIG. 4, includes a light source 410 serving as a heat source, a laser beam transmission optical system 420 for transmitting light to the connecting portion, a mechanical jig 430 for supporting and pressing the connecting portion of the anisotropic conductive film, a manipulation panel 440, and a controller 450.

The light source 410 includes a diode laser or Nd:YAG laser, having an infrared band wavelength (about 800 nm to 1100 nm), and generates a laser beam with a predetermined intensity according to the control of the controller 450.

The laser beam transmission optical system 420 includes an optical fiber 33 for transmitting a laser beam from the light source 410 to the jig 430, an optical system fixture 424 for supporting the optical system 420, a laser beam expander 426 for expanding the laser beam transmitted through the optical fiber 422 to a size and a shape suitable for projection and a scan driver 428 for transporting the laser beam expander 426 to project the laser beam 402 to the connecting portion of materials to be connected by the controller 450. Meanwhile, other optical components may be used instead of the optical fiber 422 for transmitting the laser beam. The optical system can project a spot-shaped laser beam having a predetermined diameter, a line-shaped laser beam having a predetermined length, and a rectangular spot-shaped laser beam, onto the connecting portion. The projection of the laser beam can be repeated by control of the controller 450, and the laser beam can be projected to a predetermined area of the ACF at a time. At this time, in order to impart the connecting portion with a predetermined strength the jig 430 supports and presses the connecting portion during the projection of the laser beam.

The jig 430 includes a base 432 on which the ACF 406 and materials to be connected to each other are accumulated on a substrate 404 such as an LCD panel, glass, FR4, FR5, FPC, or the like, a pressing device 434 for pressing the substrate 404 and the materials when the laser beam is projected and having an optical window for passing the laser beam 402, and a pressure driver 436 for driving the pressing device 434 at a predetermined pressure under the control of the controller 450. The substrate 404 and the material 408 have respective bumps (or pads) 404a and 408a for electrical connection. After placing the ACF 406 between the bumps 404a and 408a, the laser beam 402 is projected and the pressing device 434 presses the material 408. Then, the bumps 404a and 408a are electrically connected to each other in one direction by the conductive balls of the ACF 406, and the adhesive of the ACF 406 fills the space between the bumps 404a and 408a to firmly connect the substrate 404 to the material 408.

The manipulation panel 440 includes a keypad and an LCD such that key inputs are transmitted to the controller 450 to control the anisotropic conductive film bonding apparatus. The manipulation panel 440 displays operating status of the anisotropic conductive film bonding apparatus under the control of the controller 450.

The controller 450 determines every variable (such as wavelength and/or intensity, projection manner, projection time of the laser beam, and pressure, or the like) for the process using the input values from the keypad of the manipulation panel 440, controls every part of the anisotropic conductive film bonding apparatus according to the key input by the worker, and displays the controlled result, operating status, or the like on the LCD of the manipulation panel 440.

The process for bonding the substrate to the material using the ACF performed by the anisotropic conductive film bonding apparatus will be described in detail in the following.

First, the substrate 404, such as the base film, glass, or the like to be bonded, is placed on the base 432 of the jig 430, the ACF 406 is placed on the substrate 404, and the material 408 is placed on the ACF 406. At that time, the substrate 404 and the material 408 must be precisely placed at their positions to connect the bumps 404a and 408a, and this process, not depicted in the drawings, is preferably performed by an automated apparatus such as a robot.

Next, the light source 410 emits light with a predetermined wavelength and intensity absorbable by the base film of the connection portion of the ACF or the ITO film of the glass substrate under control of the controller 450. The emitted light may be continuously emitted or may be pulses.

The emitted laser beam is transmitted to the laser beam transmission optical system 420 including the optical fiber 422 or mirror, and passes through the optical system fixture 424 for connecting the optical fiber 422 to the laser beam expander 426 of the laser beam transmission optical system 420. The laser beam is expanded into a laser beam with a spot having a predetermined size by the laser beam expander 426 before being projected onto the connecting portion.

The expanded laser beam 402 is projected onto the connecting portion by passing through the optical widow 434a having very high permeability (higher than 99%) with respect to a laser beam. The optical window 434a is fixed to the pressing device 434 to transmit the laser beam 402 and press the connecting portion with a predetermined pressure.

In the case of connecting a base film as the upper material 408 to the glass substrate having the ITO pattern as in the preferred embodiment of the present invention, the ACF connection as the main process of the present invention can be performed by the following two processes according to laser beam absorption source.

In the first of the processes, the base film is used as the laser beam absorption source, and in this case, the laser beam 402 enters the upper side of the base film, like the process using the hot bar. The laser beam is absorbed by the base film and is transformed into thermal energy. Heat generated from the portion absorbing the laser beam is rapidly transferred to the ACF 406 though the bump terminal (having a thickness of several tens micrometers) plated with copper or gold on the lower end of the base film. Time necessary for raising temperature to a predetermined degree centigrade and welding the ACF as a thermosetting adhesive and hardening the welded ACF is adjusted by precisely controlling the output of the laser beam by the controller 450. In order to enhance quality of the connection between the bump 408a and the ITO 404a, proper pressing is performed.

Another one of the processes is a process for projecting the laser beam to the lower end of the glass substrate 404. The laser beam is absorbed by the ITO 404a coated on the glass substrate. The glass substrate 404 transmits most of laser beams with wavelengths in infrared band, and the ITO film 404a absorbs some part of the laser beam. Since the output per unit area of the laser beam is greater than ordinary lights, the laser beam generates sufficient heat even when only a fraction of the laser beam is absorbed. The laser beam absorbed in the ITO film 404a is transformed into thermal energy and the thermal energy is transmitted to the ACF 406. The connection process after this process is identical to the first of the processes.

As described above, according to the present invention, the process using the hot bar as a heat source for the connection of the anisotropic conductive film is replaced with the process using a diode laser, so that reliability and precision of the process can be achieved, the processing time can be also reduced, and full-automated process can enhance productivity. Moreover, the present invention can be applied to a small-sized precise packaging in the fields of electronics/semiconductors and biotechnology/environment technology. Particularly, the anisotropic conductive film bonding apparatus according to the present invention generates heat only in the portion to be connected and precisely controls the output of the laser beam so that excellent repair and process reliability can be achieved. According to the present invention, since temperature required to weld the anisotropic conductive film is raised in a short time, the processing time is also reduced. Moreover, the connection of various materials can be achieved by using laser beam absorption characteristics of respective materials with respect to wavelengths of laser beams.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1.-3. (canceled)

4. An anisotropic conductive film bonding method for positioning an anisotropic conductive film between a substrate and a material to be connected and for connecting the substrate to the material to be connected using the anisotropic conductive film, the method comprising the steps of:
generating a laser beam with a predetermined wavelength;
projecting the laser beam on the substrate and the material for a predetermined time;
pressing the material during the projection of the laser beam; and
connecting the substrate to the material such that the substrate or the material absorbs the laser beam and is heated to melt adhesive in the anisotropic conductive film, and conductive balls in the anisotropic conductive film are destroyed due to the pressing to provide unidirectional conductivity to the anisotropic conductive film.

5. The anisotropic conductive film bonding method as set forth in claim 4, wherein, the step of projecting the laser beam comprises the sub-steps of:
transforming the laser beam into a spot-shaped laser beam, a line-shaped laser beam, or a laser beam with a spot having a certain area for the projection;
projecting the laser beam onto the upper end of a base film when the substrate is the base film such that the base film absorbs the laser beam to generate heat; and
projecting the laser beam onto the lower end of a glass substrate when the substrate is a glass substrate such that indium tin oxide coated on the glass substrate absorbs the laser beam to generate heat.

6. The anisotropic conductive film bonding method as set forth in claim 4, wherein the predetermined wavelength of the laser beam is in the range of 800 nm to 1100 nm, the projection time of the laser beam is in the range of 5 sec to 20 sec, and the pressure is in the range of 250 Kg/cm² to 600 Kg/cm².
